(19) United States
(12) Patent Application Publication
(10) Pub. No.: US 2026/0120356 A1
(43) Pub. Date: Apr. 30, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: MITSUHIDE SATAKE, Kanagawa (JP)

(21) Appl. No.: 18/999,105

(22) Filed: Dec. 23, 2024

(30) Foreign Application Priority Data
Feb. 27, 2024 (JP) 2024-027499

(51) Int. Cl. G06T 11/60; G06F 3/04845; G06V 10/764

(52) U.S. Cl. CPC G06T 11/60; G06F 3/04845; G06V 10/764

(57) ABSTRACT

An object is to make it possible to easily set an appropriate prompt for obtaining a content of a desired style with a generative AI. An information processing apparatus: obtains a base image serving as a base of a content desired to be generated with a generative AI and a style image representing a style of the content; extracts, from the obtained style image, attribute information indicating the style represented by the style image; and sets, based on the extracted attribute information, a prompt for the generative AI to generate the content based on the base image.

### BACKGROUND

### Field

The present disclosure relates to setting of a prompt for an image generative artificial intelligence (AI).

### Description of the Related Art

Services for assisting creation of posters, flyers, and the like have been provided which allow anyone to easily obtain a product of certain quality by adding any text and/or image or images to a desired template selected from among various templates prepared in advance. There is a case where one edits image contents included in a selected template while keeping the layout of the template. For example, one may desire to change a poster advertising an event for the hot season to one advertising an event for the cold season. In this case, if the poster contains an image of a person wearing light clothing, it will be necessary to change the clothing to a heavy one suitable for the cold season. Moreover, in a case where the poster contains images of multiple persons, it will be necessary to change the clothing of all of the persons.

Meanwhile, generative AI technology has made it possible to generate required contents in recent years. In the generative AI technology, in a case where a user inputs an image or text as an input prompt into a generative model, text, an image, a video, or the like that is likely to match the “context” expressed by the input prompt is generated. Using this technology the user can easily change multiple image contents included in a template. Note that the user needs to edit the multiple image contents with the same context taken into consideration.

Also, Japanese Patent Laid-Open No. 2017-037557 discloses a technique involving extracting, from property information of objects included in a template, information indicating what kind of image the template is and, based on this information, creating a search keyword for searching for an image that matches the template.

### SUMMARY

An information processing apparatus according to an aspect of the present disclosure is an information processing apparatus for causing a generative AI to generate a content, the information processing apparatus including: at least one memory that stores instructions; and at least one processor that executes the instructions to: obtain a base image serving as a base of a content desired to be generated with the generative AI and a style image representing a style of the content; extract, from the obtained style image, attribute information indicating the style represented by the style image; and set, based on the extracted attribute information, a prompt for the generative AI to generate the content based on the base image.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an information processing system;

FIG. 2 is a diagram illustrating an example of a hardware configuration of an image output apparatus;

FIG. 3 is a diagram illustrating an example of hardware configurations of a client personal computer (PC) and a server;

FIG. 4 is a functional block diagram of the information processing system;

FIG. 5 is a diagram illustrating an example of an image generation process;

FIG. 6 is a diagram illustrating an example of a layout data database (DB);

FIG. 7 is a diagram illustrating an example of a layout data editing screen;

FIG. 8 is a flowchart illustrating a flow of an image generation process;

FIG. 9 is a diagram illustrating an example of the layout data editing screen;

FIG. 10 is a functional block diagram of an information processing system;

FIG. 11 is a diagram illustrating an example of a layout data DB;

FIG. 12 is a diagram illustrating an example of a layout data editing screen; and

FIG. 13 is a flowchart illustrating a flow of an image generation process.

### DESCRIPTION OF THE EMBODIMENTS

With the technique of Japanese Patent Laid-Open No. 2017-037557, however, it is necessary to perform an operation of creating property information for each of various templates and check the property information. Hence, an appropriate prompt cannot be easily set.

Embodiments of a technique of the present disclosure will be specifically described below with reference to the drawings. Note that the following embodiments do not limit the technique of the present disclosure according to the claims, and not all the combinations of the features described in the embodiments are necessarily essential for the solution to be provided by the technique of the present disclosure. In the accompanying drawings, identical or similar components are denoted by the same reference signs, and overlapping description is omitted. Each of the processes (steps) in the flowcharts is denoted with a prefix “S.”

### Embodiment 1

An information processing system according to Embodiment 1 will be described. The information processing system according to the present embodiment is a printing system that performs editing of layout data for image output apparatuses. In the printing system, an externally connected client PC edits layout data and sends print jobs to the image output apparatuses. In a case of creating a print job, an operation of editing print settings is performed as necessary on a screen displayed on the display of a display apparatus included in the client PC.

### (Configuration of Information Processing System)

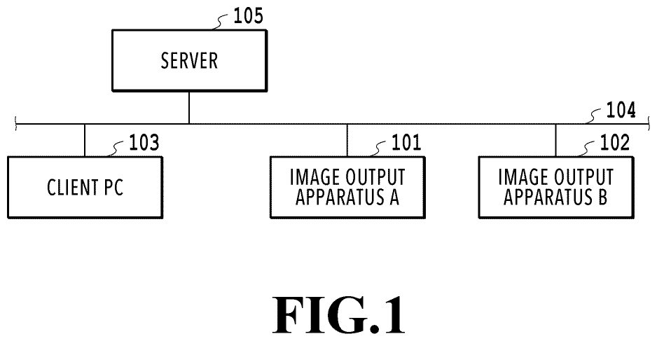

FIG. 1 is a diagram illustrating an example of a configuration of the information processing system according to the present embodiment. The information processing system according to the present embodiment has an image output apparatus A 101, an image output apparatus B 102, a client PC 103, and a server 105, which are connected to one another so as to be capable of exchanging data through a network 104, such as an Ethernet network, for example.

A layout data creation application is installed in the client PC 103. By executing the layout data creation application, the user performs an operation of editing layout data of a poster, a flyer, or the like. The client PC 103 requests the server 105 to perform editing and data processing of part of the layout data as well as rendering. Further, the client PC 103 attaches print settings to the edited layout data to generate a print job, and sends the generated print job to the image output apparatuses 101 and 102. In the present embodiment, there are two image output apparatuses, there may be one image output apparatus or three or more image output apparatuses. There are also one client PC and one server, may be two or more client PCs and servers.

In the present embodiment, an example in which a printing application installed in the client PC sends a print job to the image output apparatus A 101 through a printer driver will be described as an example of executing printing. For example, the printing application and the printer driver are installed in the client PC 103. The printing application is capable of obtaining device information of the associated image output apparatus A 101 and print parameters such as a paper type, a paper size, and a print quality from the printer driver, and editing print settings among the obtained print parameters.

A print job is formed based on the above print settings and a layout data image subjected to rendering by the server 105, and the print job is sent to the image output apparatus through a print driver's spool to execute a print process. The image output apparatus executes printing based on the print settings in the print job received. The image output apparatus also holds configuration information on the inks and papers which it uses, and status information indicating an idle state, print errors, and so on as the device information. Further, in a case where it is impossible to properly execute the printing due to a problem with the image output apparatus, such as insufficient paper or empty ink, or due to a print setting error, a warning message is displayed on the panel on the main body to present the reason why the printing cannot be performed normally to the user. (Hardware Configuration of Image Output Apparatuses)

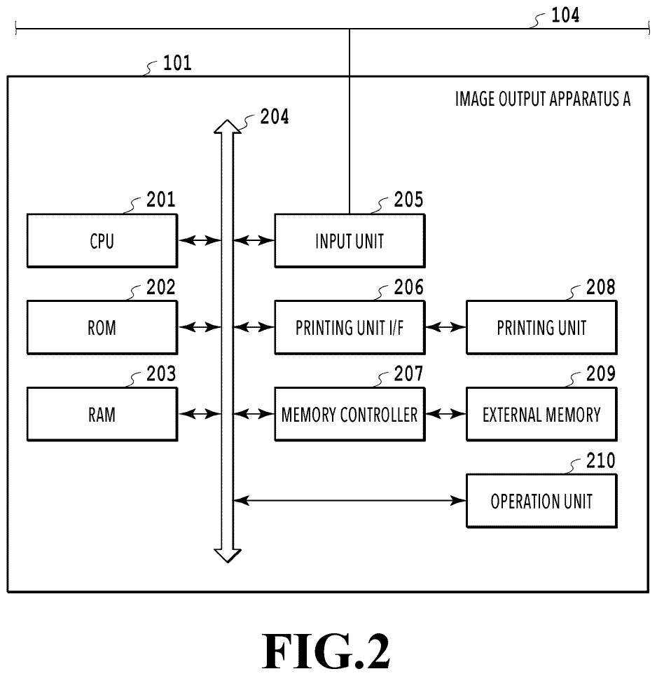

FIG. 2 is a diagram illustrating an example of a hardware configuration of the image output apparatus A 101. Note that the image output apparatus B 102 has a similar hardware configuration to that of the image output apparatus A 101, and description of the hardware configuration example of the image output apparatus B 102 is omitted. The image output apparatus A 101 is controlled by a central processing unit (CPU) 201. The CPU 201 operates based on a control program or the like stored in a program read-only memory (ROM) in a ROM 202 or a control program or the like stored in an external memory 209. The CPU 201 outputs an image signal as output information to a printing unit (printer engine) 208 connected to a printing unit interface (I/F) 206 through a system bus 204. The CPU 201 is capable of performing a communication process with the client PC 103 through an input unit 205, and notifying the client PC 103 of information inside the image output apparatus A 101. The CPU 201 is also capable of receiving output data to be output to the printing unit 208 through the input unit 205. A random-access memory (RAM) 203 functions as a main memory, a work area, and the like for the CPU 201, and is configured to be capable of expanding the memory capacity with an optional RAM connectable to an expansion port not illustrated. The RAM 203 is used as an output information loading region, an environment data storage region, a non-volatile memory, and the like. The external memory 209 includes a hard disk drive (HDD), an integrated circuit (IC) card, or the like, access to which is controlled by a memory controller 207. The external memory 209 is optionally connected and stores font data, an emulation program, form data, information on the inks to be used and the type and size of the paper to be fed, information on the main body's status, and so on. Also, an operation unit 210 includes a panel and is configured to be capable of displaying various information.

### (Hardware Configuration of Client PC and Server)

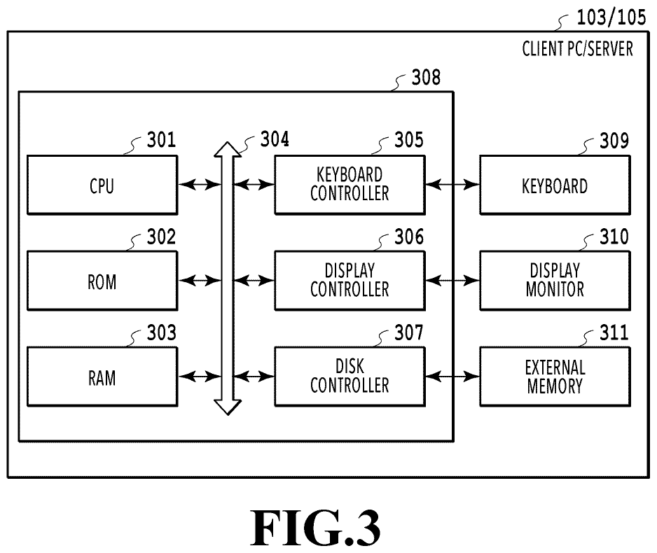

FIG. 3 is a block diagram illustrating an example of hardware configurations of the client PC 103 and the server 105. The client PC 103 and the server 105 are information processing apparatuses, such as PCs, for example. The client PC 103 and the server 105 share a common hardware configuration and have an inside 308 of a computer. The inside 308 of the computer has a CPU 301, a ROM 302, a RAM 303, a keyboard controller 305, a display controller 306, and a disk controller 307. The CPU 301 reads various programs such as a control program, a system program, and an application program out of an external memory 311 via the disk controller 307 into the RAM 303. The CPU 301 then executes the various programs read out into the RAM 303 to, for example, perform various types of data processing and control the display of a display monitor 310. The CPU 301 may be configured to read the control program and so on out of the ROM 302. The CPU 301 may be a dedicated circuit such as an application-specific integrated circuit (ASIC). The CPU 301 and the dedicated circuit represent examples of a hardware circuit and hardware processor.

The disk controller 307 controls access to the external memory 311, such as an HDD, a compact disc read-only memory (CD-ROM), a digital versatile disc read-only memory (DVD-ROM), or a universal serial bus (USB) flash drive. The RAM 303 is configured such that its capacity can be expanded with an optional RAM or the like not illustrated, and is used mainly as a work area for the CPU 301. The keyboard controller 305 controls key inputs from a keyboard 309 and a pointing device not illustrated.

The display controller 306 controls the display of the display monitor 310. Note that, in the present embodiment, the CPU 301 controls each component connected to a main bus 304 through the main bus 304, unless otherwise noted. The server 105 does not have to include components that are not necessarily essential, such as the display monitor 310, as a matter of course.

### (Functional Arrangement of Information Processing System)

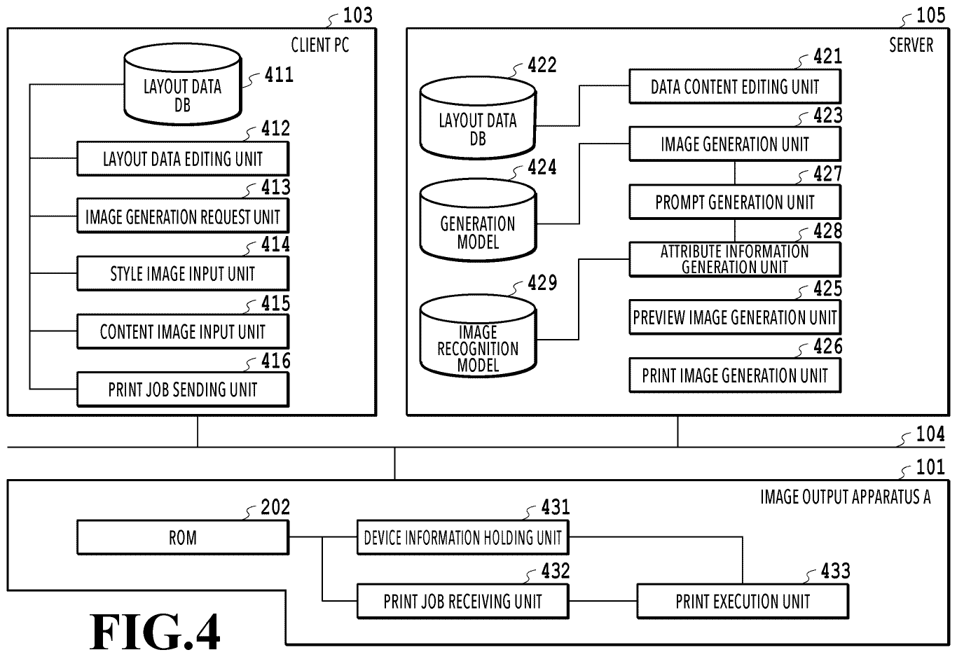

FIG. 4 is a block diagram illustrating an example of a functional arrangement of the information processing system according to the present embodiment. In the information processing system according to the present embodiment, the image output apparatus A 101 is set as an output target. First, functional arrangements inside the client PC 103 and the server 105 will be described.

### (Functional Arrangement of Client PC)

The client PC 103 has a layout data DB 411, a layout data editing unit 412, an image generation request unit 413, a style image input unit 414, a content image input unit 415, and a print job sending unit 416.

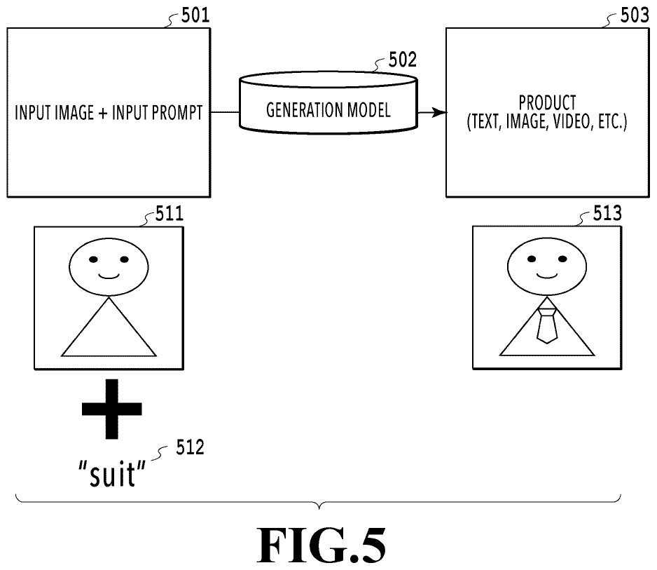

The layout data DB 411 stores layout data. Details of the layout data will be described later using FIG. 5.

The layout data editing unit 412 adds and deletes contents such as text and images to be included in posters and flyers and adjusts the layouts of contents. In a case of performing processes such as cropping and filling on a content, the layout data editing unit 412 requests a data content editing unit 421 of the server 105 to perform the processes. Layout data is stored in the layout data DB 411 of the client PC 103 as cached data. Alternatively, layout data is stored in a layout data DB 422 of the server 105 for each client PC 103 (or for each account in a case where there are user accounts).

The image generation request unit 413, based on image information set in the style image input unit 414 to be utilized in image generation and image information set in the content image input unit 415, requests an image generation unit 423 of the server 105 to generate an image.

The style image input unit 414 sets an identifier (ID) representing a style image that is image information to be utilized in image generation. The content image input unit 415 sets an ID representing a content that is a base image serving as the base of a content which is desired to be generated with a generative AI and that represents a content to be converted.

The print job sending unit 416 creates a print job and sends the created print job to the image output apparatus A 101. In a case of creating a print job, the print job sending unit 416 requests a preview image generation unit 425 of the server 105 to generate a preview of layout data and requests a print image generation unit 426 to perform a process of generating a print image.

### (Functional Arrangement of Server 105)

The server 105 has the data content editing unit 421, the layout data DB 422, the image generation unit 423, a generative model 424, the preview image generation unit 425, the print image generation unit 426, a prompt generation unit 427, and an attribute information generation unit 428.

The data content editing unit 421 edits a content or contents by performing processes such as cropping and filling on the content or contents. The layout data DB 422 is synchronized with the layout data DB 411 and stores the same layout data as the layout data DB stored in the layout data DB 411. Details of the layout data will be described later using FIG. 5.

The image generation unit 423 firstly obtains attribute information generated by the attribute information generation unit 428 based on image information set in the style image input unit 414, and generates a prompt based on the obtained attribute information by using of the prompt generation unit 427. The image generation unit 423 generates a new image based on the generated prompt by utilizing the generative model 424. The generated new image is stored in the layout data DBs 411 and 422 and reflected on a layout data editing screen.

The image generation unit 423 utilizes generative AI technology, and generates a product from an input image and an input prompt as an input with the generative model. Specifically, the image generation unit 423 utilizes a generative model such as Stable Diffusion (“Stable Diffusion” at https://arxiv.org/abs/2112.10752 on the Internet (searched online on Feb. 8, 2024) (hereafter referred to as Non-patent Document 1)), ChatGPT (registered trademark) (“ChatGPT (registered trademark)” at https://arxiv.org/abs/2303.08774v4 on the Internet (searched online on Feb. 8, 2024), and/or a generative adversarial network (GAN), which is a generative adversarial algorithm. FIG. 5 is a diagram for describing an image generation process using a generative model. A generative model 502 is capable of outputting an image 513 as a product 503 in response to accepting an input 501 consisting of an input image 511 and an input prompt 512. The image 513 is likely to match the “context” expressed by the input 501. The relationship between an input value and “context” is obtained when the generative model 502 is trained using many images and sentences. Also, the input-output combination of a generative AI technology differs from those of others depending on the generative model used, and the user needs to use an appropriate generative AI technology and generative model as necessary.

The generative model 424 is a model to be used in a case where the image generation unit 423 generates an image. Note that the generative model 424 is capable of using the same input image and input prompt to output different images as products with by changing an initial value that is generated mainly from a random number at the time of generating the image. In a case of converting the image style to “watercolor painting,” “abstract painting,” or “animation,” the following generative model may be used. Specifically, a generative model may be used which has been trained with images of specific image styles to convert an input image according to the taste of an image or images used in the training and outputs the converted image, like Neural Style Transfer (“Neural Style Transfer” disclosed at https://arxiv.org/abs/1508.06576 on the Internet (searched online on Feb. 8, 2024)).

The preview image generation unit 425 generates a preview of layout data. The print image generation unit 426 executes a process of generating a print image. The prompt generation unit 427 generates a prompt based on attribute information. Details of the generation of a prompt will be described later.

The attribute information generation unit 428 performs image recognition on an image set in the style image input unit 414 with an image recognition model 429 and generates attribute information indicating the contents of the image. Details of the generation of the attribute information will be described later. The image recognition model 429 is a model which the attribute information generation unit 428 uses to generate the attribute information.

### (Functional Arrangement of Image Output Apparatus A)

Next, a functional arrangement of the image output apparatus A 101 will be described. The image output apparatus A 101 has a device information holding unit 431, a print job receiving unit 432, and a print execution unit 433. The device information holding unit 431, the print job receiving unit 432, and the print execution unit 433 are connected to the ROM 202 of the image output apparatus A 101. The device information holding unit 431 holds information on the types, remaining amounts, and the like of the inks mounted in the image output apparatus A 101, information on the types, sizes, and the like of registered papers and papers to be fed, information on the status of the main body of the image output apparatus A 101, and information the statuses of print jobs. The print job receiving unit 432 receives print jobs sent from the client PC 103. The print execution unit 433 executes a print process on each of the print jobs.

In a case where the image output apparatus A 101 has been determined in advanced as an image output apparatus to be utilized, the following process may be performed in order to create layout data suitable for the image output apparatus A 101, as a matter of course. Specifically, the device information held in the device information holding unit 431 may be obtained, and the obtained device information may be held in the client PC 103 or the server 105 in association with the layout data stored in the layout data DB 411 or 422.

### (Layout Data)

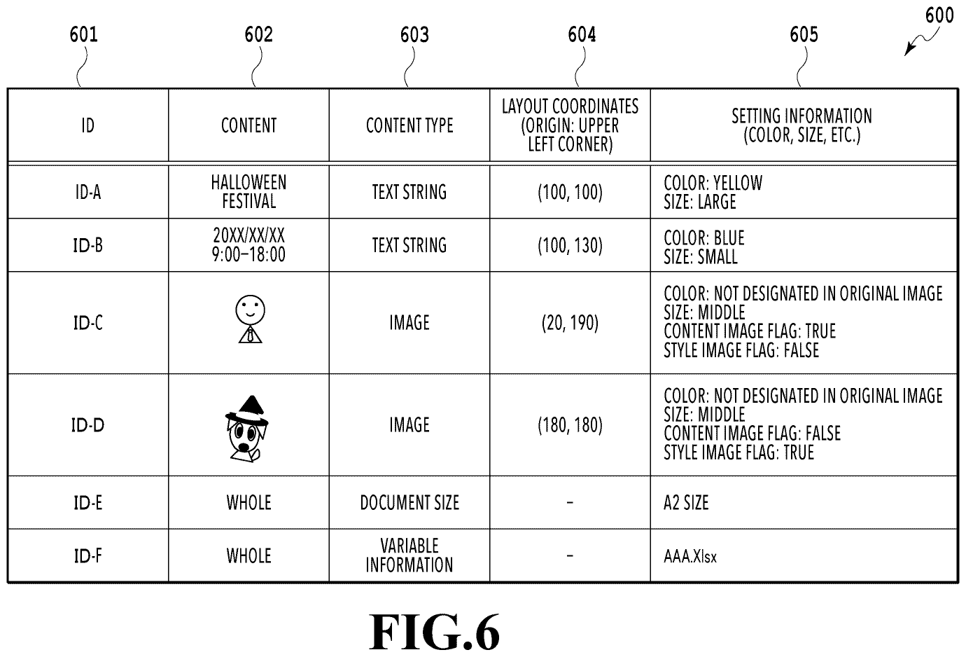

FIG. 6 is a diagram illustrating an example of the layout data stored in the layout data DBs 411 and 422. A data table 600 illustrated in FIG. 6 is present for each piece of layout data. The data table 600 includes parameters such as an ID 601, a data content 602, a content type 603, layout coordinates 604, and setting information 605. Under the ID 601, pieces of identification information for uniquely identifying contents in the layout data are registered. In FIG. 6, six pieces of identification information “ID-A,” “ID-B,” “ID-C,” “ID-D,” “ID-E,” and “ID-F” are registered. The pieces of information indicated under the items of the data content 602, the content type 603, the layout coordinates 604, and the setting information 605 are associated with the corresponding pieces of identification information indicated under the ID 601.

Under the item of the data content 602, the value of each content, such as text or an image, that is arranged in the layout data is set. Under the content type 603, pieces of content type information indicating the types of the contents, such as “text string,” “image,” “document size,” and “variable information,” for example, are set.

Under the item of the layout coordinates 604, sets of coordinates which are values indicating the positions of the contents in the layout data with the upper left corner as a reference position are set. Under the item of the setting information 605, each content's attribute values, such as the content's color and size, are set. Additionally, under the item of the setting information 605, a style image flag indicating whether the image is a style image and a content image flag indicating whether the image is a content image are set. In the present embodiment, a style image and a content image are defined as follows.

In the present embodiment, suppose a case where an image is generated using a generative model that receives an image and text as an input and outputs an image, like Stable Diffusion disclosed in Non-patent Document 1. The image input into the generative model in the above case is a content image. Moreover, an image used to generate the text input into the generative model is a style image. The style image flag and the content image flag each express how the image already arranged in the layout data will be utilized in the image generation.

Also, the data table 600 holds settings on the entirety of the layout data, such as the document size and data for variable printing, and is capable of holding “Whole” under the data content 602, a setting type under the content type 603, and a setting value under the setting information 605. Each parameter type may be handled in a separate file, and parameter types other than the above may be included in the layout data, as a matter of course.

### (Layout Data Editing Screen)

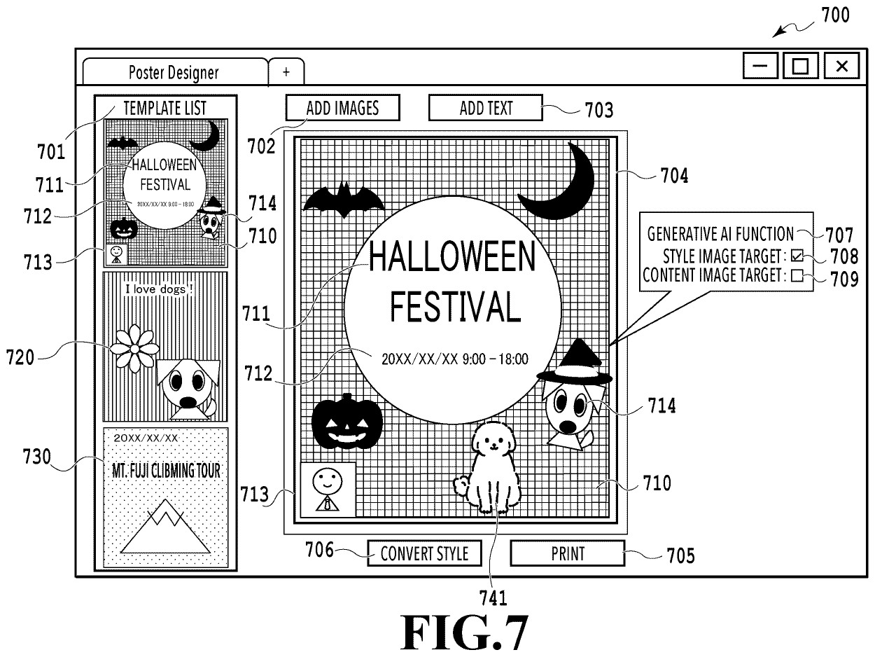

FIG. 7 is a diagram illustrating an example of the layout data editing screen according to the present embodiment. A layout data editing screen 700 is a user interface (UI) screen to be displayed on the display monitor 310 of the client PC 103 and directed to the image output apparatus A 101 as an output target (print execution target). Suppose that, in FIG. 7, a template 710 in a template list 701 has been selected, and a content 741 has been added to the template 710 displayed in a layout editing area 704 as a result of a user operation on an image addition button 702. Suppose also that a content 714 in the layout editing area 704 is in a selected state in order to set whether it is a style image target or a content image target.

The layout data editing screen 700 displays the template list 701, the image addition button 702, a text addition button 703, the layout editing area 704, a print execution button 705, a style conversion button 706, and a generative AI function area 707. The generative AI function area 707 displays a style image target check box 708 and a content image target check box 709.

The template list 701 displays multiple (three in the illustrated example) templates 710, 720, and 730 prepared in advance. The user can browse the multiple templates displayed in the template list 701 and select the template that is most closely matches a completed image of the layout data. In a case where a template is selected by a user operation, the selected template is displayed in the layout editing area 704. In FIG. 7, the template 710 has selected by a user operation from among the multiple templates 710, 720, and 730 displayed in the template list 701, and the selected template 710 is displayed in the layout editing area 704. Note that template information of each template displayed in the template list 701 may be obtained as layout data from the layout data DB 411 or 422 or from a social networking service (SNS) or another external cloud service.

The layout editing area 704 is an area where contents included in the displayed template can be edited. Specifically, in the layout editing area 704, each of the multiple contents displayed by the layout data editing unit 412 and the data content editing unit 421 can be subjected to editing such as positional adjustment, cropping, and filling. Also, the user can press the image addition button 702 or the text addition button 703 to be described later to add a content such as an image or text to the template displayed in the layout editing area 704.

The image addition button 702 is a button for accepting a user operation of adding an image to the template displayed in the layout editing area 704. The text addition button 703 is a button for accepting a user operation of adding text to the template displayed in the layout editing area 704. In a case where the image addition button 702 or the text addition button 703 is pressed by a user operation, a desired content will be added to the template displayed in the layout editing area 704. Specifically, a file dialogue will be called and, in response to designation of a path to a file, an import process will be performed to add a desired content. Other buttons corresponding to content types may be additionally arranged, and/or an external cloud service storage or an SNS may be designated as an import source, as a matter of course. Also, the layout data editing screen 700 may accept addition of a content to the template displayed in the layout editing area 704 via drag and drop.

The print execution button 705 is a button for accepting a user operation of executing printing of the image displayed in the layout editing area 704. In a case where the user presses the print execution button 705, the layout data editing unit 401 requests the print job sending unit 416 to create a print job and send the created print job to the image output apparatuses 101 and 102. The print job is a print job for the layout data displayed in the layout editing area 704.

The style conversion button 706 is a button for accepting a user operation of converting a selected content to make it match the style image or images included in the template image. Specifically, the style conversion button 706 is a button for accepting a user operation of converting the style of a selected content to make it match the style of the style image or images included in the template image. The selected content is, for example, a content (an image or text) included the template image displayed in the layout editing area 704 and added to the template image by a user operation on the image addition button 702 or the text addition button 703. The style conversion button 706, being a button for converting a style as described above, can be said to accept whether to execute conversion by a generative AI with a set prompt for an input new content. Incidentally, as for the timing to operate the style conversion button 706, whether to execute the conversion may be accepted each time a new content is input, or the conversion may be executed in a case of accepting an instruction from the user.

The generative AI function area 707 is an area which, in a case of generating an image with the generative AI function, indicates the target image is a style image target or a content image target. The generative AI function area 707 displays the style image target check box 708 and the content image target check box 709 for each of the multiple images displayed in the layout editing area 704.

The style image target check box 708 is an item to be used to set the target image as a style image target. The content image target check box 709 is an item to be used to set the target image as a content image target.

Pressing the style conversion button 706 through a user operation will start conversion of the content image to match the style of the style image or images displayed in the layout editing area 704. The image generation request unit 413 sets a content image and a style image designated from among the images in the layout editing area 704 in the content image input unit 415 and the style image input unit 414, respectively. Then, the style of the designated content image is converted to match the style of the style image to generate a new image, and the generated new image is presented to the user. That is, the style of the designated content image is converted to match the style of the style image, and the content image after the style conversion is presented to the user. In a case where multiple content images are designated, the multiple content images are set in the content image input unit 415. Also, in a case where multiple style images are designated too, the designated multiple style images are set in the style image input unit 414. As for the method of designating a style image, a style image target check box may be displayed for each of the multiple contents in the layout editing area 704 and accept selection through a user operation. Alternatively, the images in the layout editing area 704 other than the images set as content images may all be selected as style images.

Also, as for the method of presenting a new image to the user, in a case where a content image in the layout editing area 704 is designated, the designated content image in the layout editing area 704 may be replaced with a new image and the new image may be presented. Alternatively, another content may be newly added to have the user select the image to employ between the designated content image and the new image.

### (Image Generation Process)

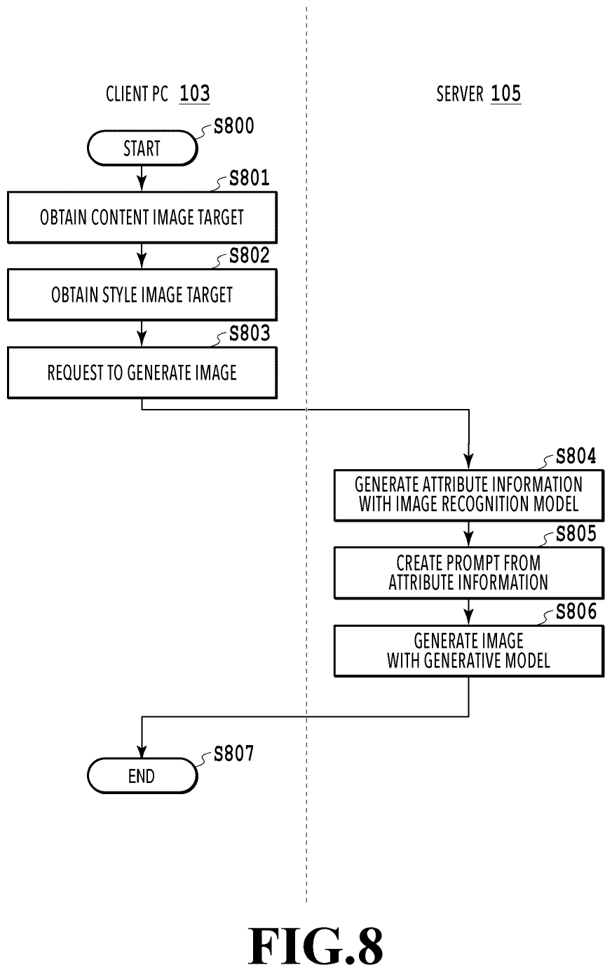

FIG. 8 is a flowchart illustrating a flow of an example of an image generation process according to the present embodiment. FIG. 8 illustrates a flow of a process of generating an image matching the images that have already been arranged in the layout data editing screen 700 with the generative AI. Specifically, FIG. 8 illustrates a flow of a process in which all of the contents included in a template have been set as style images in advance, and the style of an added image is converted to match the style of the style images. The CPU 301 implements the flowchart illustrated in FIG. 8 by reading out a program stored in the ROM 302 into the RAM 303 and executing it, for example.

In S800, the client PC 103 starts the flow illustrated in FIG. 8 by using of the image generation request unit 413 at a timing at which the style conversion button 706 in the layout data editing screen 700 is pressed, for example. Suppose that a template that has been selected from the template list 701 and a desired content image that has been added are displayed in the layout editing area 704 in the layout data editing screen 700, and the added content image is selected.

In S801, the image generation request unit 413 obtains the content image designated in the layout editing area 704 and sets the ID indicating the obtained content image in the content image input unit 415. In a case where multiple content images are designated in the layout editing area 704, the image generation request unit 413 sets each of the IDs of the images designated as the content images in the content image input unit 415. Suppose, for example, that the content 741 has been added by a user operation on the image addition button 702, and the content image target check box 709 in the generative AI function area 707 displayed for the content 741 is selected. In this case, the ID associated with the content 741 is set in the content image input unit 415.

In S802, the image generation request unit 413 obtains a style image designated in the layout editing area 704 and sets the ID indicating the obtained style image in the style image input unit 414. In a case where multiple style images are designated in the layout editing area 704, the image generation request unit 413 sets each of the IDs of the images designated as the style images in the style image input unit 414. Suppose, for example, that the style image target check box 708 in the generative AI function area 707 displayed for the content 714 in the layout editing area 704 is selected. In this case, the ID associated with the content 714 is set in the style image input unit 414.

In S803, the image generation request unit 413 requests the image generation unit 423 of the server 105 to generate a new image based on the information set in the content image input unit 415 and the information set in the style image input unit 414. Specifically, the image generation request unit 413 requests the image generation unit 423 to generate a content image in a converted style by converting the style of the content image to match the style of the style image. For example, the image generation request unit 413 requests the image generation unit 423 to generate an image based on the ID of the content 741 set in the content image input unit 415 and the ID of the content 714 set in the style image input unit 414.

In S804, using an image recognition technique, the attribute information generation unit 428 extracts and obtains attribute information from the image set in the style image input unit 414, the attribute information indicating the contents of the image. In the above image recognition technique, a model that has been trained to classify particular elements such as seasons, events, and image styles may be used. A generative model may be used which receives an image as an input and generates text that is descriptive text, like Show and Tell (“Show and Tell” disclosed at https://arxiv.org/abs/1411.4555 on the Internet (searched online on Feb. 8, 2024)). The attribute information generation unit 428 may obtain, for example, information indicating a season, such as “spring” or “winter,” information indicating an event, such as “Christmas” or “Halloween,” and/or information indicating an image style, such as “watercolor painting,” “abstract painting,” or “animation,” as the attribute information. For example, the attribute information generation unit 428 extracts pieces of information such as “dog” and “Halloween” as the attribute information from the content 714.

Also, the image recognition model may be trained to include an item like “not applicable” in its classification results to exclude attributes that are considered mismatching. Also, the attribute information generation unit 428 may obtain an attribute in the form of descriptive text, such as “Santa Claus is standing in front of a house on a winter night.”

In S805, the prompt generation unit 427 generates an image generation prompt to be set in the image generative AI based on the attribute information extracted from the style image. For example, the prompt generation unit 427, based on the attribute information “dog” and “Halloween” extracted from the content 714, extracts information such as “Halloween” as the image generation prompt to be set in the image generative AI.

In S806, the image generation unit 423 utilizes the generative model 424 in which the image generation prompt generated by the prompt generation unit 427 is set. The image generation unit 423 generates an image from the content image information designated in the content image input unit 415 via conversion to a style matching the style of the style image. For example, the image generation unit 423 generates a Halloween-themed content 901 from the non-Halloween-themed content 741 by utilizing the generative model 424 in which “Halloween” is set as the image generation prompt generated by the prompt generation unit 427. As a result, the image in the changed style is displayed instead of the added image in the layout editing area in the layout data editing screen.

### (Layout Data Editing Screen)

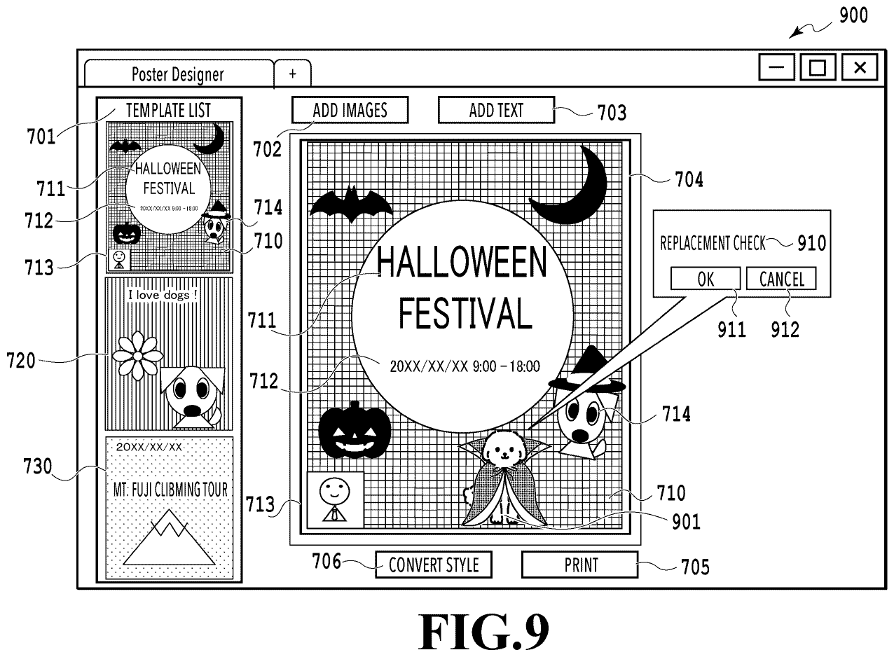

FIG. 9 is a diagram illustrating an example of the layout data editing screen according to the present embodiment. A layout data editing screen 900 is a UI screen to be displayed on the display monitor 310 of the client PC 103 and directed to the image output apparatus A 101 as an output target (print execution target). Note that FIG. 9 represents a state after the content 741 illustrated in FIG. 7 was subjected to the style conversion.

Like the layout data editing screen 700, the layout data editing screen 900 displays the template list 701, the image addition button 702, the text addition button 703, the layout editing area 704, the print execution button 705, and the style conversion button 706.

The layout data editing screen 900 further displays a replacement check area 910. The replacement check area 910 is displayed for the content subjected to the style conversion. The replacement check area 910 displays an OK button 911 and a cancel button 912. The replacement check area 910 is an area for checking whether to confirm replacement of the target image with the converted image after the conversion of the target image's style with the generative AI function. The OK button 911 is a button for accepting a user operation of confirming the replacement of the content image before the style conversion with the content image after the style conversion. The cancel button 912 is a button for accepting a user operation of confirming cancellation of the replacement of the content image before the style conversion with the content image after the style conversion and maintenance of the content image before the style conversion. The presence of the buttons for selecting whether to permit the replacement after the conversion makes it possible to check the user's intension before performing printing and prevent unnecessary printing.

### (Process of Generating Image Generation Prompt)

Details of the process of generating an image generation prompt (S805) will now be described. In a case where there is a single style image, the extracted attribute information may be used as is, or information in the extracted attribute information that indicates the image's atmosphere or style may be preferentially used. For example, in a case where attributes such as “winter,” “dog,” and “joyful” are extracted, “winter” and “joyful” are general attributes that indicate the image's atmosphere or style whereas “dog” is a definite attribute as compared to the image's atmosphere or style. For example, designating “dog” as an input prompt while an image of a person is designated as a content image is likely to convert the person with a dog, which may greatly change the image's impression. In contrast, designating “winter” and “joyful” as an input prompt while an image of a person is designated as a content image will change the impression to a lesser extent than with “dog.” Thus, using general information as a prompt allows an image to be adjusted so as not to be extremely changed from the original content image's impression. For the purpose of preferentially using general information, a dedicated image recognition model that extracts only styles and atmospheres may be used as the image recognition model with which the attribute information generation unit 428 extracts attribute information.

In a case where there are multiple style images, attribute information is obtained from each of the multiple style images. All of the obtained pieces of attribute information may be used to make an image generation prompt. Alternatively, the obtained pieces of attribute information may be counted up by type, and the piece of attribute information with the largest count in each type may be used to set an image generation prompt. In the case where there are multiple style images, the attribute information generation unit 428 uses a dedicated image recognition model that classifies the season, event, and image style to obtain one event, image style, and season as attribute information from each single style image. Suppose that three images are designated as style images and the following attribute information is obtained from each style image.

TABLE 1

Attribute Information

| Style Image | Event | Image Style | Season |
|---|---|---|---|
| Style Image 1 | Christmas | Animation | Winter |
| Style Image 2 | Not Applicable | Watercolor | Winter |
| | | Painting | |
| Style Image 3 | Christmas | Watercolor | Winter |
| | | Painting | |

In this case, among the pieces of attribute information on the events in all style images, there are two “Christmas,” making it the most frequent event, so that “Christmas” is used as a prompt. Likewise, among the pieces of attribute information on the image styles in all style images, there are two “watercolor painting,” making it the most frequent image style, so that “watercolor painting” is used as a prompt. Among the pieces of attribute information on the seasons in all style images, there are three “winter,” making it the most frequent season, so that “winter” is used as a prompt. As a result, “Christmas, watercolor painting, winter” is generated as an image generation prompt.

Also, an image generation prompt that strongly reflects attributes that are shared by many style images among the obtained pieces of attribute information may be generated. For example, consider a case where a word or a phrase placed at the head of a prompt strongly affects the image to be generated. Referring to the above-described example with multiple style images, “winter” is obtained as a season attribute from all of the style images 1 to 3 and is considered a common attribute shared by all of the designated style images. As an image style attribute, “watercolor painting” is obtained from two of the three style images but is not considered a common feature shared by all of the style images, unlike “winter.” Hence, it is considered more appropriate to place “winter” at the head of the prompt to be generated. In a case of creating a prompt using the pieces of attribute information in multiple style images in order of commonality, “winter, Christmas, watercolor painting, animation” is a possible example of the prompt to be generated.

Also, in a case where pieces of attribute information are obtained in the form of a sentence, those pieces of attribute information may further be summarized into an image generation prompt. For example, like GPT-3 (“GPT-3” disclosed in https://arxiv.org/abs/2005.14165 on the Internet (searched on Feb. 8, 2024)), an input such as “Output a word or a phrase that describes a common atmosphere shared by the following three sentences.” may be input into a generative model that receives as text as an input and outputs text, and the resulting output may be used as an image generation prompt.

Also, a word or a phrase that is highly likely to be used in prompts may be set as a prompt template in advance and added to a prompt generated from attribute information. In one possible example, a word or a phrase for outputting a high-quality image, such as “masterpiece” or “best quality,” may be held in advance and added at the head of a prompt generated from attribute information. Also, templates suitable for conversion methods that are likely to be used may be set in advance, and the contents of any of the templates designated by a user operation may be added to a prompt. For example, in a case where the style is frequently converted to an animation or illustration style, phrases may be set and added as follows. Specifically, phrases such as “a sketch of” and “an illustration of” may be set as prompt templates in advance, and the user may, for example, add any of the phrases to a prompt by designating “animation” or the like as an option at the time of conversion.

Further, multiple prompts may be generated from attribute information to generate multiple images and have the user select one of them. It is possible that prompts result in generation of different images even if the same content image is designated, for example, depending on the orders of the words and/or phrases in the prompts. Thus, multiple images may be generated by changing the order of the words and/or phrases in a prompt. Also, prompt templates such as “animation,” “realistic,” or “abstract painting” prepared as templates may each be added to a prompt generated from attribute information to generate multiple prompts. Then, multiple images may be generated from the prompts and the content image.

As described above, in the present embodiment, in a case of generating an image suitable for images in layout data, an image generation prompt is automatically created and set from a style image or images included in a template that indicate a style. Thus, an appropriate prompt for obtaining a desired content that matches the contents already arranged in a template is easily set. This eliminates the need for operations such as setting information that describes a content for each single one of multiple images included in various templates before creating a poster or a flyer. Accordingly, an image with a style matching the style of images included in a template can be generated.

Also, in a case where there are multiple targets to be edited by a generative AI, the user can easily designate a prompt for the multiple editing targets. Further, it is also possible to reduce burdens on content providers for setting a prompt for each image content.

### Embodiment 2

In Embodiment 2, an aspect in which attribute information of each individual style image and a prompt can be corrected through user operations will be described. Note that, in the present embodiment, its difference from Embodiment 1 will be mainly described.

### (Functional Arrangement of Information Processing System)

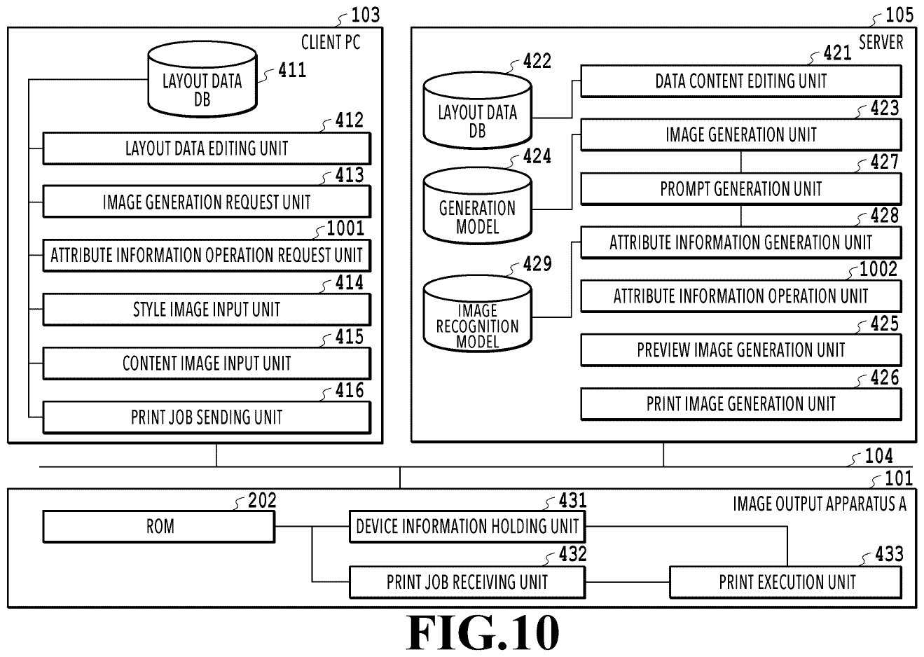

FIG. 10 is a block diagram illustrating an example of a functional arrangement of an information processing system according to the present embodiment. In the information processing system according to the present embodiment, an image output apparatus A 101 is set as an output target (print execution target). A client PC 103 according to the present embodiment has the same functional units 411 to 416 as those of the client PC 103 according to Embodiment 1 and further has an attribute information operation request unit 1001. Also, a server 105 according to the present embodiment has the same functional units 421 to 429 as those of the server 105 according to Embodiment 1 and further has an attribute information operation unit 1002.

The attribute information operation request unit 1001 requests the attribute information operation unit 1002 to perform attribute information operations. The attribute information operation unit 1002 performs operations related to attribute information.

### (Layout Data)

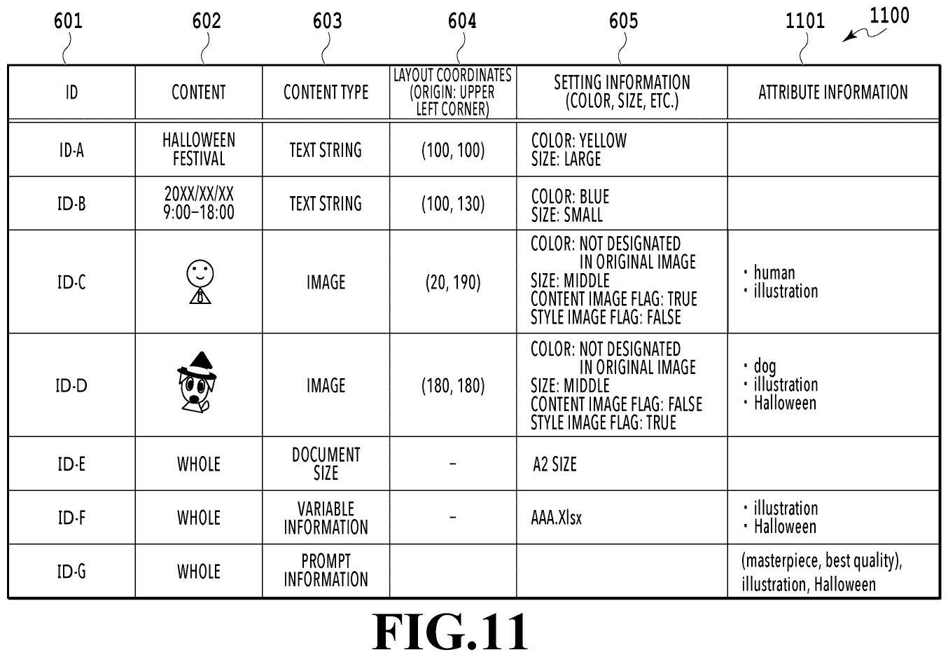

FIG. 11 is a diagram illustrating an example of the layout data stored in the layout data DBs 411 and 422 according to the present embodiment. A data table 1100 according to the present embodiment has attribute information 1101 in addition to the pieces of information on the items 601 to 605 included in the data table 600 according to Embodiment 1. Under the attribute information 1101, attribute information is added for each individual image. Also, for ID-G, a prompt representing attribute information of the entirety is added. In addition to attribute information obtained from the dog image with ID-D, which is a style image, a prompt is set in which “masterpiece” and “best quality” prepared for the template are added.

### (Layout Data Editing Screen)

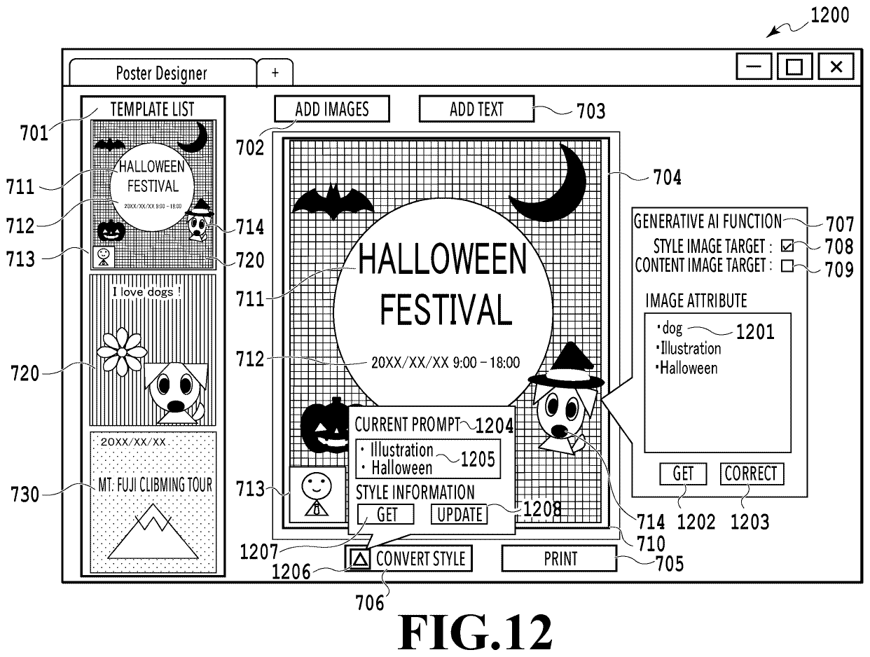

FIG. 12 is a diagram illustrating an example of a layout data editing screen according to the present embodiment. Like the layout data editing screen 700, a layout data editing screen 1200 is a UI screen to be displayed on the display monitor 310 of the client PC 103 and directed to the image output apparatus A 101 as an output target (print execution target). Incidentally, in FIG. 12, a template 710 in a template list 701 is selected. Also, in order to correct the attribute information of a content 714, the content 714 is selected and a style image attribute display portion 1201 is displayed. Moreover, a prompt information input portion 1205 is displayed to update the prompt.

Like the layout data editing screen 700, the layout data editing screen 1200 displays a template list 701, an image addition button 702, a text addition button 703, a layout editing area 704, and a print execution button 705. The layout data editing screen 1200 also displays a style conversion button 706 and a generative AI function area 707. The generative AI function area 707 displays a style image target check box 708 and a content image target check box 709. The generative AI function area 707 further displays the style image attribute display portion 1201, an attribute obtaining button 1202, and an attribute correction button 1203. The layout data editing screen 1200 displays an accordion button 1206 for style conversion. Performing a user operation on the accordion button 1206 will display a detail box 1204 for prompt information of the layout data. The detail box 1204 displays the prompt information input portion 1205, a prompt information obtaining button 1207, and a prompt information update button 1208.

The style image attribute display portion 1201 displays the attribute information of the style image. In a case where the style image target check box 708 in the generative AI function area 707 set for an image is selected and checked by a user operation and then the attribute obtaining button 1202 is pressed, the following process is performed. Specifically, the attribute information operation request unit 1001 requests the attribute information generation unit 428 of the server 105 to generate attribute information of the style image, and stores the generated attribute information of the style image in the layout data DB 422. The layout data editing unit 412 reads the information stored in the layout data DB 422 and displays the attribute information in the style image attribute display portion 1201. The user can correct the attribute information displayed in the style image attribute display portion 1201 by using of a keyboard input and the like. Pressing the attribute correction button 1203 through a user operation after correcting the attribute information will update the attribute information of the style image stored in the layout data DB 422.

Also, the detail box 1204 for the prompt information of the layout data is displayed in a case where the user selects the accordion button 1206 through a mouse operation. The prompt information input portion 1205 requests the attribute information operation unit 1002 to obtain a prompt by using of the attribute information operation request unit 1001 based on the style image designated by the style image target check box 708 in response to the prompt information obtaining button 1207 being pressed by a user operation. The attribute information operation unit 1002 obtains the attribute information of the target style image from the layout data DB. Also, in a case where attribute information does not exist for the target style image, the attribute information operation unit 1002 also obtains attribute information from the attribute information generation unit 428 for that style image. Then, the prompt generation unit 427 generates a prompt based on the attribute information and updates the prompt information in the layout data DBs 411 and 422 with the generated prompt. The layout data editing unit 412 reads the information in the layout data DB and displays the prompt information generated based on the attribute information of the style image in the prompt information input portion 1205. Further, in a case of correcting the prompt information, the user can do so by inputting a prompt into the prompt information input portion 1205. In a case where the user presses the prompt information update button 1208, the attribute information operation request unit 1001 requests the attribute information operation unit 1002 to update the prompt information in the layout data DB 422 with the information input into the prompt information input portion 1205. Then, in a case where the user presses the style conversion button 706, the target content image is converted based on the prompt information updated by the user's input. In this way, the user can manually make fine adjustments to the contents of the conversion.

### (Image Generation Process)

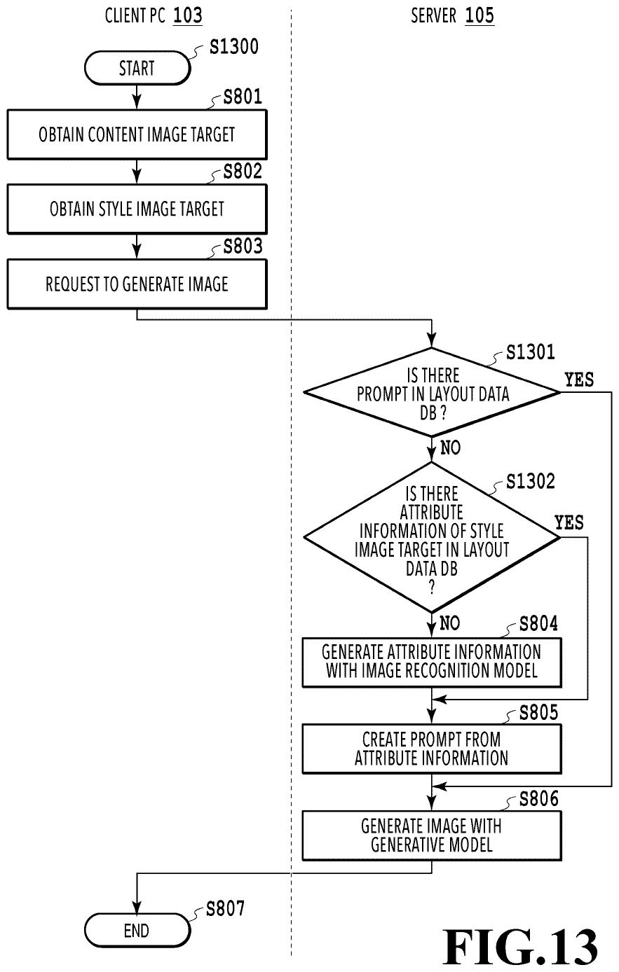

FIG. 13 is a flowchart illustrating a flow of an image generation process according to the present embodiment. FIG. 13 illustrates a flow of a process of generating an image matching the images that have already been arranged in the layout data editing screen 1200 with a generative AI. Specifically, FIG. 13 illustrates a flow of a process in which all of the contents included in a template have been set as style images in advance, and the style of an added image is converted to match the style of the style images. The CPU 301 implements the flowchart illustrated in FIG. 13 by reading out a program stored in the ROM 302 into the RAM 303 and executing it, for example.

In S1300, the client PC 103 starts the flow illustrated in FIG. 12 at a timing at which the style conversion button 706, the attribute correction button 1203, or the prompt information update button 1208 in the layout data editing screen 1200 is pressed, for example. In the present embodiment, unlike Embodiment 1, the prompt information obtaining button 1207 or the prompt information update button 1208 may have been pressed, resulting in a prompt already being stored in the layout data DB 422.

In S1301, the server 105 determines whether a prompt is stored in the layout data DB. In the case where a determination result indicating that a prompt is stored in the layout data DB is obtained (YES in S1301), the process proceeds to S806. On the other hand, in the case where a determination result indicating that a prompt is not stored in the layout data DB is obtained (NO in S1301), the process proceeds to S1302. For example, in a case where a user operation has been performed on the prompt information obtaining button 1207 or the prompt information update button 1208, there should be prompt information already stored in the layout data DBs 422 and 411, and the process therefore proceeds to S806. On the other hand, in a case where no user operation has been performed on the prompt information obtaining button 1207 or the prompt information update button 1208, there should be no prompt information stored in the layout data DB 422 or 411, and the process therefore proceeds to S1302.

In S1302, the server 105 determines whether there is attribute information on the image designated in the content image input unit 415. In the case where a determination result indicating that there is attribute information on the image designated in the content image input unit 415 is obtained (YES in S1302), the process proceeds to S805. On the other hand, in the case where a determination result indicating that there is no attribute information on the image designated in the content image input unit 415 is obtained (NO in S1302), the process proceeds to S804. For example, in a case where a user operation has been performed on the attribute obtaining button 1202 or the attribute correction button 1203, there should be attribute information already stored in the layout data DBs 422 and 411, and the process therefore proceeds to S805. On the other hand, in a case where no user operation has been performed on the attribute obtaining button 1202 or the attribute correction button 1203, there should be no attribute information stored in the layout data DB 422 or 411, and the process therefore proceeds to S802.

Note that S804 to S806 involve similar processes to those in Embodiment 1, and detailed description thereof is therefore omitted.

As described above, according to the present embodiment, the user can obtain attribute information of individual images and a prompt and correct them by making fine adjustments or doing a similar operation and then generate an image. This makes it easier to generate a desired image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

In the above, an aspect applied to a layout data creation application as an application example has been described, but the present disclosure is not limited to this. The present disclosure is applicable to any application with an image layout function similar to the above layout data creation application.

In the above, a PC that is an information processing apparatus is has been exemplarily described as the client PC 103, but the present disclosure is not limited to this. For example, any information processing apparatus (terminal) such as a cellular phone, a portable information terminal, a digital still camera, a digital video camera, a portable music player, a game console, a set-top box, or an Internet appliance that can be used in a similar manner can be employed.

In the above, an Ethernet has been exemplarily described as a network configuration, but the present disclosure is not limited to this. For example, any other network configuration such as a wireless local area network (LAN), IEEE 1394, or Bluetooth, may be employed.

In the above, an aspect in which all of the contents included in a template are set as style images in advance, but the present disclosure is not limited to this. For example, some contents among all of the contents included in a template may be set as style images in advance, or not all of the contents included in the template may be set as a style image or a content image. In this case, all of the contents included in the template may be individually set as a style image or a content image.

In the above, an aspect has been described in which, for each of “season,” “event,” “image style,” “style,” and “atmosphere,” a dedicated image recognition model is used to extract information indicating a season, event, image style, style, or atmosphere as attribute information. However, the present disclosure is not limited to this. For example, in a case where a template contains a person or the like, a dedicated image recognition model may be used to recognize their expression, such as joy or sadness, and extract information indicating the expression as attribute information. Also, in the case where a template contains a person or the like, a dedicated image recognition model may be used to recognize their state such as being happy or being sad, and extract information indicating the emotion as attribute information.

In the above, an aspect has been described in which, in a case where attribute information or a prompt is corrected, the corrected attribute information or prompt is stored in the layout data DBs 422 and 411. However, the present disclosure is not limited to this. For example, attribute information extracted from a style image may be stored in the DBs 422 and 411 in association with the style image, and the attribute information stored in the DBs 422 and 411 may be used in a case of converting the style of a content based on the style image. For example, a prompt created from attribute information may be stored in the DBs 422 and 411 in association with the style image corresponding to the attribute information, and the prompt stored in the DBs 422 and 411 may be used in a case of converting the style of a content based on the style image.

According to the present embodiment, it is possible to easily set an appropriate prompt for obtaining a content of a desired style.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-027499, filed Feb. 27, 2024, which is hereby incorporated by reference wherein in its entirety.

What is claimed is:

1. An information processing apparatus for causing a generative AI to generate a content, the information processing apparatus comprising:
at least one memory that stores instructions; and
at least one processor that executes the instructions to:
obtain a base image serving as a base of a content desired to be generated with the generative AI and a style image representing a style of the content;
extract, from the obtained style image, attribute information indicating the style represented by the style image; and
set, based on the extracted attribute information, a prompt for the generative AI to generate the content based on the base image.

2. The information processing apparatus according to claim 1, wherein the attribute information is extracted by performing image recognition using an image recognition model.

3. The information processing apparatus according to claim 1, wherein
in a case where a plurality of style images representing the style of the content are obtained, a plurality of pieces of the attribute information are extracted for the plurality of style images, and
the prompt is set based on the extracted plurality of pieces of attribute information.

4. The information processing apparatus according to claim 3, wherein, in the setting of the prompt, the at least one processor executes the instructions further to:
classify the extracted plurality of pieces of attribute information by type; and
set the prompt based on a most frequent piece of attribute information in each of the types used for the classification.

5. The information processing apparatus according to claim 1, wherein
the attribute information which includes preset setting information is extracted, and
the prompt is set based on the attribute information with the extracted setting information.

6. The information processing apparatus according to claim 3, further comprising a user interface that accepts a user operation, wherein, in the setting of the prompt, the at least one processor executes the instructions further to:
generate a plurality of prompts from the plurality of pieces of attribute information; and
set a prompt selected by the user operation accepted via the user interface among the generated plurality of prompts.

7. The information processing apparatus according to claim 1, further comprising a storage that stores the prompt, wherein
in a case where the storage has stored the prompt for the style image, the prompt according to the style image stored in the storage is set.

8. The information processing apparatus according to claim 7, wherein the at least one processor executes the instructions further to correct the prompt stored in the storage based on a user operation, wherein
in the setting of the prompt, the corrected prompt is set.

9. The information processing apparatus according to claim 8, wherein the prompt is corrected with the user operation performed on a UI screen displayed on a display.

10. The information processing apparatus according to claim 1, further comprising a storage that stores the attribute information, wherein
in a case where the storage has stored the attribute information corresponding to the style image, the stored prompt is set.

11. The information processing apparatus according to claim 10, wherein the at least one processor executes the instructions further to correct the attribute information stored in the storage based on a user operation, wherein
the prompt is set based on the corrected attribute information.

12. The information processing apparatus according to claim 11, wherein the attribute information is corrected with the user operation performed on a UI screen displayed on a display.

13. The information processing apparatus according to claim 1, further comprising a user interface that accepts whether to execute conversion by the generative AI with the set prompt for an input new content.

14. The information processing apparatus according to claim 13, wherein the user interface accepts whether to execute the conversion each time the new content is input.

15. The information processing apparatus according to claim 13, wherein the at least one processor executes the conversion in a case of accepting a user instruction with the user interface.

16. The information processing apparatus according to claim 1, wherein the attribute information is extracted as at least one of information indicating a season, information indicating an event, information indicating an image style, information indicating an atmosphere, information indicating an emotion, or information indicating an expression.

17. The information processing apparatus according to claim 1, wherein the at least one processor executes the instructions further to generate a product incorporating a content generated by the generative AI, wherein
the style image is obtained from a template prepared for the product.

18. An information processing method for causing a generative AI to generate a content, the information processing method comprising:
obtaining a base image serving as a base of a content desired to be generated with the generative AI and a style image representing a style of the content;
extracting, from the obtained style image, attribute information indicating the style represented by the style image; and
setting, based on the extracted attribute information, a prompt for the generative AI to generate the content based on the base image.

19. A non-transitory computer readable storage medium storing a program for causing a computer to perform an information processing method for causing a generative AI to generate a content, the information processing method comprising:
obtaining a base image serving as a base of a content desired to be generated with the generative AI and a style image representing a style of the content;
extracting, from the obtained style image, attribute information indicating the style represented by the style image; and
setting, based on the extracted attribute information, a prompt for the generative AI to generate the content based on the base image.
